(19) United States
(12) Patent Application Publication
(10) Pub. No.: US 2006/0162171 A1
(43) Pub. Date: Jul. 27, 2006

(54) Base plate for an electric tool and method for manufacturing same

(76) Inventors: Wolfgang Fuchs, Filderstadt (DE); Heiko Roehm, Stuttgart (DE); Juergen Gairing, Stuttgart (DE); Jens Blum, Filderstadt (DE)

Correspondence Address: Striker Striker & Stenby, 103 East Neck Road, Huntington, NY, 11743, US

(21) Appl. No.: 10/523,851

(22) PCT Filed: Jul. 14, 2004
(86) PCT No.: PCT/DE04/01525

§ 371 Date: Feb. 7, 2005

(30) Foreign Application Priority Data
Sep. 12, 2003 (DE) 103 42 154.8

(51) Int. Cl. B27B 9/04; B23D 51/02

(52) U.S. Cl. 30/374

(57) ABSTRACT

In a base plate (1) for a power tool (13), in particular for hand-guided circular saws, sabre saws, wall chasers, and routers, comprised of a metal sheet, having reinforcing elements that protrude out from the plane of the metal sheet, at least one of which is embodied in the form of a lateral stop surface (12), and having attaching elements (14) that protrude out from the plane of the metal sheet for fastening the base plate (1) to the miter angle (23), a more favorable manufacture with a low weight and higher rigidity with simultaneously lower risk of breakage is achieved in that the metal sheet is comprised of light metal and the entire base plate (1) is embodied in one piece. According to the present invention, a base plate (1) of this kind is manufactured by means of a stamping and bending process.

### PRIOR ART

The invention is based on a base plate for a power tool with the species-defining characteristics of claim 1.

Known base plates for hand-guided circular saws, sabre saws, wall chasers, and routers are embodied as flat components with a low structural height. They serve to guide the power tool on a work piece. There are three basic embodiment forms of base plate.

The first group of known base plates includes those that are stamped and bent out of sheet steel. They typically have a circumferential collar and longitudinal reinforcing creases that serve to increase rigidity since the sheet thicknesses lie in a range of only 1.5 to 2.5 mm. Components like this are favorable from a manufacturing standpoint because among other things, technical functions like accommodation of a parallel cutting guide or pivot points for angle adjustment can be performed by parts that can be formed directly out of the metal sheet, without requiring subsequent finishing work. Moreover, warped base plates can also be bent back again. However, such base plates have the disadvantage of being heavy.

The second group of known base plates includes stamped parts that are made of light metal and do not have circumferential collars. In order to achieve a sufficient degree of rigidity, sheet thicknesses of 5 to 6 mm are used. However, add-ons are required in order to perform the above-mentioned technical functions. A base plate of this kind has a low weight and can also be bent back again when warped. But a base plate of this kind is also expensive to manufacture because it must be equipped with add-ons.

The third group of known base plates includes cast components made of light metal alloys that do in fact have a very low weight and a high degree of rigidity, but it is very expensive to manufacture these base plates because they require subsequent finishing work. Cast components of this kind also tend to break under impact.

### ADVANTAGES OF THE INVENTION

A base plate for a power tool according to the present invention with the characteristics of claim 1 has the advantage over the prior art that using of a sheet of light metal and a one-piece design of the base plate can result in an advantageous manufacture; the base plate has only a low weight with a high degree of rigidity, can be bent back again when warped, and also does not break under impact. According to the present invention, a base plate of this kind is manufactured using a stamping and bending method.

Embodying the sheet with a material thickness of less than 4 mm, in particular 3 mm, yields a particularly lightweight base plate that nonetheless has a sufficient degree of rigidity. It is particularly advantageous to use a sheet comprised of an aluminum alloy.

Embodying at least one reinforcing element in the form of a circumferential collar yields a base plate with a particularly high degree of rigidity and a low weight. A particularly favorable degree of rigidity is achieved if the circumferential collar has a height that is at least twice the material thickness of the sheet.

Embodying at least one reinforcing element in the form of a lateral, diagonal, or longitudinal reinforcing crease increases the rigidity of the base plate even further.

Providing an integral embodiment of projections and a threaded dome for guiding and positioning a parallel cutting guide that is integral to the base plate obviates the need to provide add-ons to the base plate in order to attach a parallel cutting guide. When connecting elements for an angle adjustment of a saw blade are embodied as integral to the base plate, it is also unnecessary to provide additional add-ons for pivoting the cutting plane. Embodying a guide channel as integral to the base plate makes it possible to place the power tool onto a guide rail without requiring add-ons to do so. The three measures mentioned above each achieve a reduction in the manufacturing costs of the base plate, which add up to a considerable savings potential when the three measures are combined.

Because the connecting elements have bores that define a rotation axis for the angle adjustment of a saw blade, the base plate has the elements-which are required to be able to change the angle of a saw blade-already integrated into it, without requiring other add-ons. This allows the base plate to be inexpensively manufactured.

Other advantageous embodiments of the present invention are the subject of the dependent claims.

### DRAWINGS

An exemplary embodiment of the invention will be explained in detail in the following description in conjunction with the accompanying drawings.

FIG. 1 is a three-dimensional depiction of a hand circular saw,

FIG. 2 is a top view of a base plate according to the present invention (rotated by 180° in relation to the one in FIG. 1), and

FIG. 3 is a three-dimensional depiction of the base plate according to the present invention shown in FIG. 2.

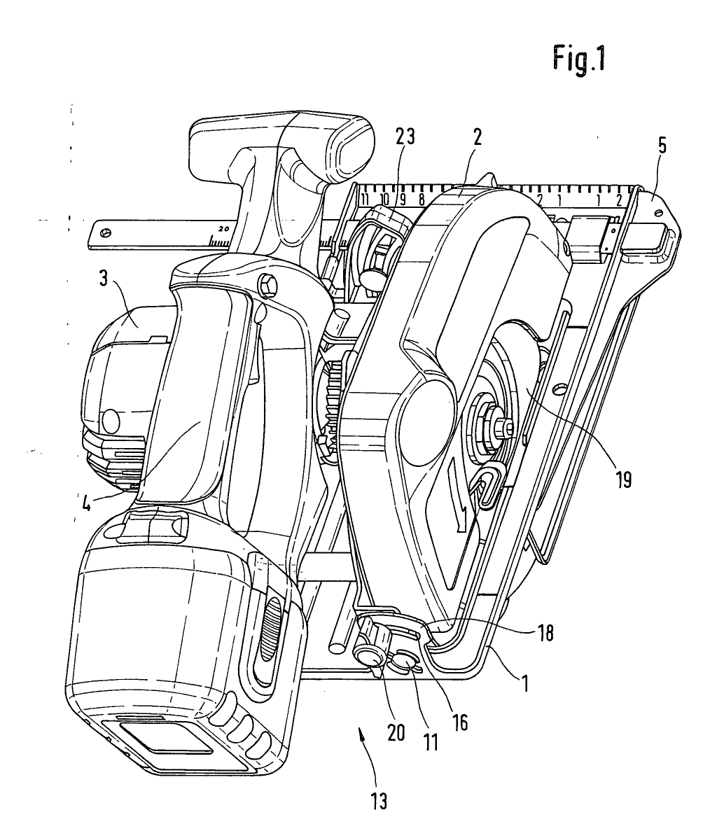

FIG. 1 shows a power tool 13 in the form of the hand-guided circular saw. The power tool 13 has a base plate 1 according to the present invention to which a motor contained in a motor housing 3 is attached. The motor drives a saw blade 19 located under a guard 2. A handle 4 is used for moving the power tool 13. An adjustable parallel cutting guide 5 is attached to the base plate 1. The saw blade 19 is connected to the base plate 1 so that it can be moved between a plane perpendicular to the base plate 1 and a sawing plane that is inclined at an angle. For this purpose, the base plate 1 is provided with a connecting element 18, which has a pivoting slot 16 and a bore 11 for accommodating the pivot pin (not shown). A pin indirectly connected to the saw blade 19 can be guided in the pivoting slot 16 and can be fixed in its position in the pivoting slot 16 by means of a wing nut 20. The above-mentioned design of the power tool 13 is in principle known from the prior art.

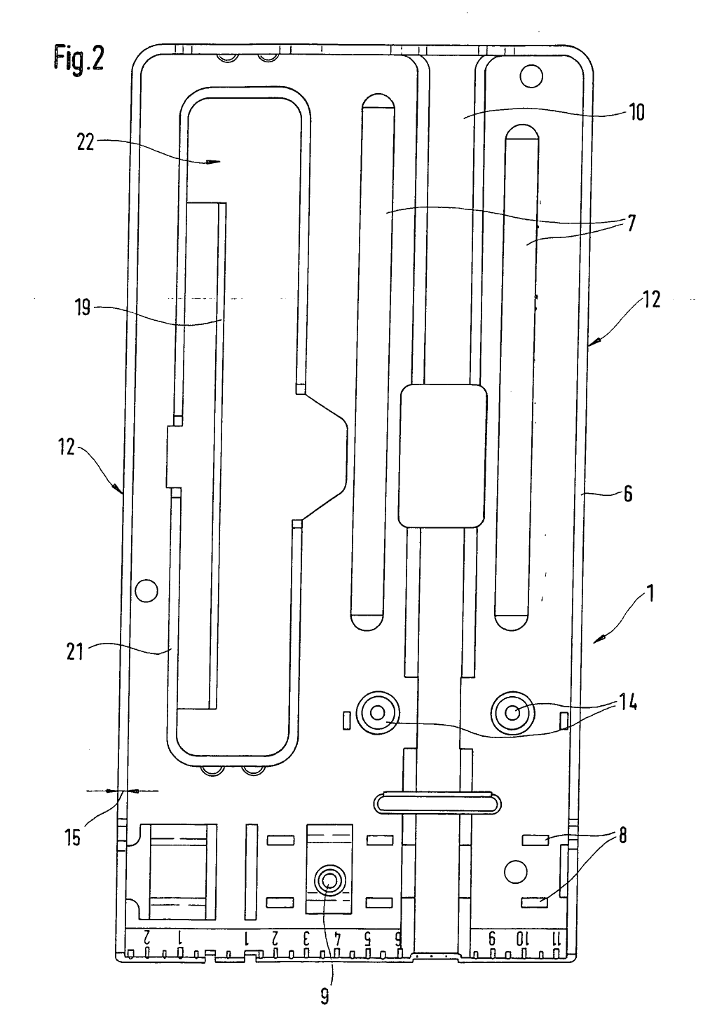

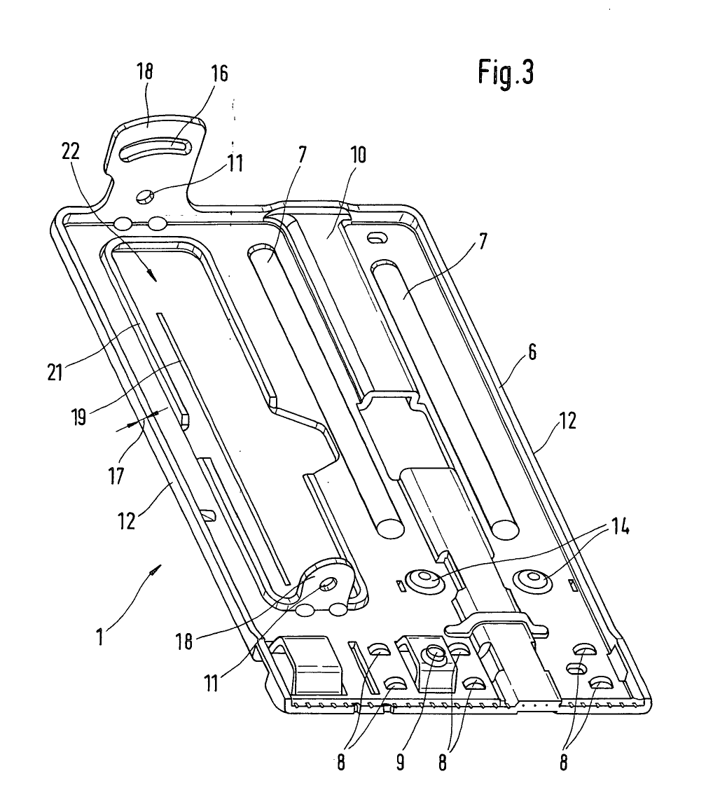

The characteristics of the base plate 1 according to the present invention can best be seen in FIGS. 2 and 3 and will be described below.

The base plate 1 is manufactured in one piece out of a sheet of light metal by means of a stamping and bending process. By contrast with a stamping process, this produces a three-dimensional form of the base plate 1. The base plate 1 depicted is comprised of an aluminum alloy with a material thickness 15 of 3 mm. A base plate 1 of this kind has a flexural rigidity comparable to that of a steel plate 2 mm thick. However, due to the significantly lower density of the aluminum alloy in comparison to that of steel, the weight has been cut roughly in half despite the increase in material thickness.

The favorable rigidity of the base plate 1 according to the present invention is achieved by means of a circumferential collar 6. The circumferential collar 6 has a height 17 that is roughly twice the material thickness 15 of the metal sheet. The inside height is roughly 6.5 mm and the outside height is roughly 9 mm. To further increase the rigidity of the base plate 1, two longitudinal reinforcing creases 7 are provided parallel to the orientation of the saw blade 19. This achieves a rigidity within the range of those in alternative embodiment forms.

In addition, the rigidity is further increased by means of an additional collar 21 that surrounds an opening 22 for the saw blade 19.

In order to accommodate a device that guides the saw blade 19, two connecting elements 18 are incorporated into the base plate 1. Both of them protrude perpendicularly up from the plane of the base plate 1. One of the two connecting elements 18 is part of the additional collar 21, the other connecting element 18 is part of the circumferential collar 6. Each of the two connecting elements 18 has a bore 11 that supports the pivot pin, which is indirectly connected to the saw blade 19 and determines the cutting plane of the saw blade. In addition to the bore 11, the connecting element 18 that is part of the circumferential collar 6 is also provided with a pivoting slot 16 whose function has already been explained above in conjunction with FIG. 1.

On its longitudinal sides, i.e. parallel to the saw blade 19, the circumferential collar 6 is embodied as a stop surface 12. This makes it easy to guide the power tool 13 along a batten or a similar straight object.

In order to be able to fasten the parallel cutting guide 5 to the base plate 1 in various positions, a threaded dome 9 is provided, which accommodates a wing nut (not shown) and securely clamps the parallel cutting guide in its position. In order to achieve a clean, parallel guidance of the parallel cutting guide 5, a number of projections 8 are provided on the base plate 1. Both the projections 8 and the threaded dome 9 here are embodied integral to the base plate 1.

A row of attaching elements 14 is incorporated into the base plate 1 in order to permit the base plate 1 to be connected to the miter angle 23. The basic connection of the base plate 1 to the miter angle 23 is well known from the prior art and is not described in detail since it is not essential to the present invention.

The above explanations regarding the material thickness 15 of the metal sheet and the height 17 of the circumferential collar 6 are merely given by way of example. It is clear to those skilled in the art that other values can also be used without going beyond the scope of the concept of the present invention.

In summary, the base plate 1 according to the present invention, which is manufactured by means of a stamping and bending process according to the present invention, achieves the advantages of the known base plate designs, namely those in the form of a stamped and bent component made of plate steel, a stamped part made of light metal, and a cast component made of a light metal alloy, without the disadvantages of the three components mentioned.

Compared to the stamped and bent component made of plate steel, the base plate 1 according to the present invention has a comparable rigidity, but a significantly reduced weight.

By contrast with stamped components that can only be embodied in two dimensions due to the stamping process, the base plate 1 according to the present invention has a significantly smaller material thickness 15. In the present case, the material thickness 15 is 3 mm, whereas stamped components typically require material thicknesses 15 of greater than 5 mm. This large material thickness 15 is necessary in order to obtain the lateral stop surface 12 that in the present case, is provided by the circumferential collar 6. In the stamped component, the height 17 of the stop surface is equal to the material thickness 15. With the known stamped components, it is also necessary to provide additional add-ons for the geometry accommodating the parallel cutting guide 5 and for the angle adjustment of the saw blade 19. On the one hand, this results in a higher material consumption and a higher weight and on the other hand, increases the cost of manufacturing the stamped component. The base plate 1 according to the present invention, however, which is comprised of a light metal alloy and has been produced by means of a stamping and bending process, is equipped with reinforcing elements that do not require the entire base plate 1 to have a greater material thickness 15. In addition, the lateral stop surfaces 12 can be set to the desired height 17 independent of the material thickness 15. The required material thickness 15 can therefore be reduced in comparison to that of stamped components while maintaining the same functionality, thus reducing both weight and cost.

A light metal cast component that has a geometry for accommodating the parallel cutting guide can in fact be used as the base plate, but the cast component requires material-removing finishing work. For this reason, a base plate 1 according to the present invention, which has been manufactured using the stamping and bending process, is less expensive because it does not require subsequent machining. Moreover, the base plate according to the present invention has the advantage of a greater ductility than a cast component. Cast metal is more brittle than metal that is suited to forming processes. This means that the cast component will break significantly more easily under impact than a component manufactured out of a rolled metal sheet. After being dropped and warped, the base plate 1 according to the present invention can be bent back into place and is once again ready for use. By contrast, a cast component tends to break when dropped. A base plate 1 according to the present invention matches the weight reduction achieved by the component cast out of light metal, which means that the cast component has no advantage over the present invention.

What is claimed is:

1. A base plate (1) for a power tool (13), in particular for hand-guided circular saws, sabre saws, wall chasers, and routers, comprised of a metal sheet, having reinforcing elements that protrude out from the plane of the metal sheet, at least one of which is embodied in the form of a lateral stop surface (12), and having attaching elements (14) that protrude out from the plane of the metal sheet and are provided for fastening the base plate (1) to the miter angle (23),
wherein the metal sheet is comprised of light metal and the entire base plate (1) is embodied in one piece.

2. The base plate (1) as recited in claim 1,
wherein the material thickness (15) of the metal sheet is less than 4 mm, in particular 3 mm.

3. The base plate (1) as recited in claim 1,
wherein the metal sheet is comprised of a light metal alloy, in particular an aluminum or magnesium alloy.

4. The base plate (1) as recited in claim 1,
wherein at least one reinforcing element (6, 7) is embodied in the form of a circumferential collar (6).

5. The base plate (1) as recited in claim 4,
wherein the circumferential collar (6) has a height (17) of at least twice the material thickness (15) of the metal sheet.

6. The base plate (1) as recited in claim 1,
wherein at least one reinforcing element (6, 7) is embodied in the form of a lateral, diagonal, or longitudinal reinforcing crease (7).

7. The base plate (1) as recited in claim 1,
wherein projections (8) and a threaded dome (9) for guiding and positioning a parallel cutting guide (5) and/or connecting elements (18) for an angle adjustment and/or a guide channel (10) are integrated into the base plate (1).

8. The base plate (1) as recited in claim 7,
wherein the connecting elements (18) have bores (11) that define a rotation axis for the angle adjustment of a saw blade (19).

9. A method for manufacturing a base plate (1) as recited in claim 1,
wherein the method is comprised of a stamping and bending process.
